(19) United States
(12) Patent Application Publication
(10) Pub. No.: US 2020/0313355 A1
(43) Pub. Date: Oct. 1, 2020

(54) ELECTRICAL CONNECTOR WITH FLOATING CONTACT ELEMENT

(71) Applicant: METHODE ELECTRONICS, INC., Chicago, IL (US)

(72) Inventors: Chip BRONK, San Jose, CA (US); Hannah HAN, Fremont, CA (US); Robert KELLER, Rolling Meadows, IL (US); Michael STIBGEN, Rolling Meadows, IL (US)

(21) Appl. No.: 16/829,877

(22) Filed: Mar. 25, 2020

Related U.S. Application Data
(60) Provisional application No. 62/823,257, filed on Mar. 25, 2019.
(60) Provisional application No. 62/916,857, filed on Oct. 18, 2019.

(51) Int. Cl. H01R 13/631; H01R 13/11

(52) U.S. Cl. CPC H01R 13/6315; H01R 13/111

(57) ABSTRACT

An electrical connector for use with a separable mating connector includes base and a contact element captively received within the base. The contact element may be laterally or laterally and rotatably displaceable with respect to the base.

### CROSS-REFERENCE TO RELATED APPLICATIONS

This application claims benefit under 35 U.S.C § 119 of U.S. Provisional Patent Application No. 62/823,257, filed on Mar. 25, 2019, and U.S. Provisional Patent Application No. 62/916,857, filed on Oct. 18, 2019, and it incorporates by reference the disclosures thereof in their entireties.

In addition, the subject matter of the following applications is incorporated herein by reference in its entirety: U.S. Utility application Ser. No. 16/829,672 filed Mar. 25, 2020, and entitled ELECTRICAL CONNECTOR WITH FLOATING CONTACT ELEMENT (B&T Ref. No. 49072-318243); U.S. Utility application Ser. No. ______ filed Mar. 25, 2020, and entitled ELECTRICAL CONNECTOR WITH FLOATING CONTACT ELEMENT (B&T Ref. No. 49072-318080); and U.S. Utility application Ser. No. 16/829,747 filed Mar. 25, 2020, and entitled ELECTRICAL CONNECTOR WITH FLOATING CONTACT ELEMENT (B&T Ref. No. 49072-318286)

### BACKGROUND AND SUMMARY OF THE DISCLOSURE

An electrical equipment cabinet may include a bus bar bearing a number of electrical connector sockets received in corresponding holes in the bus bar. A piece of electrical equipment may include mating electrical connector pins configured for insertion into the connector sockets borne by the bus bar.

Failure to precisely locate the connector sockets with respect to the bus bar and/or the connector pins with respect to the electrical equipment, for example, due to manufacturing tolerances, can result in misalignment of the sockets and pins. Such misalignment can inhibit or adversely affect the quality of the electrical connection between corresponding sockets and pins.

The present disclosure is directed to an electrical connector having a floating contact element disposed within a mounting body. The mounting body is configured for connection to a bus bar, for example, in a conventional manner, and the contact element is configured to float with respect to the mounting body. The ability of the contact element to float with respect to the mounting body allows the electrical connector to compensate for misalignment of a corresponding connector element with respect to the mounting body of the electrical connector.

### BRIEF DESCRIPTION OF THE DRAWINGS

FIG. 1 illustrates a bus bar defining four apertures and four electrical connector sockets disposed in the apertures;

FIG. 2 is a side cross sectional-view of an illustrative electrical contact element;

FIG. 3 is a top plan view of the contact element of FIG. 2;

FIG. 4 is a perspective view of a first illustrative embodiment of an electrical connector having a floating contact element disposed within a mounting body, according to the present disclosure, installed in a bus bar;

FIG. 5 is a transparent perspective view of the electrical connector of FIG. 4;

FIG. 6 is a cutaway front view of the electrical connector and bus bar of FIG. 4;

FIG. 7 is an a perspective view of a second illustrative embodiment of an electrical connector having a floating contact element disposed within a mounting body, according to the present disclosure, installed in a bus bar;

FIG. 8 is a perspective view of a contact element and a biasing element of the electrical connector of FIG. 7;

FIG. 9 is a cutaway perspective view of the electrical connector of FIG. 7 installed in a bus bar;

FIG. 10 is a perspective view of a third illustrative embodiment of an electrical connector mounted to a bus bar according to the present disclosure;

FIG. 11 is a cutaway perspective view of the electrical connector and bus bar of FIG. 10; and

FIG. 12 is a detail view of a biasing element of the electrical connector of FIG. 10.

### DETAILED DESCRIPTION OF THE DRAWINGS

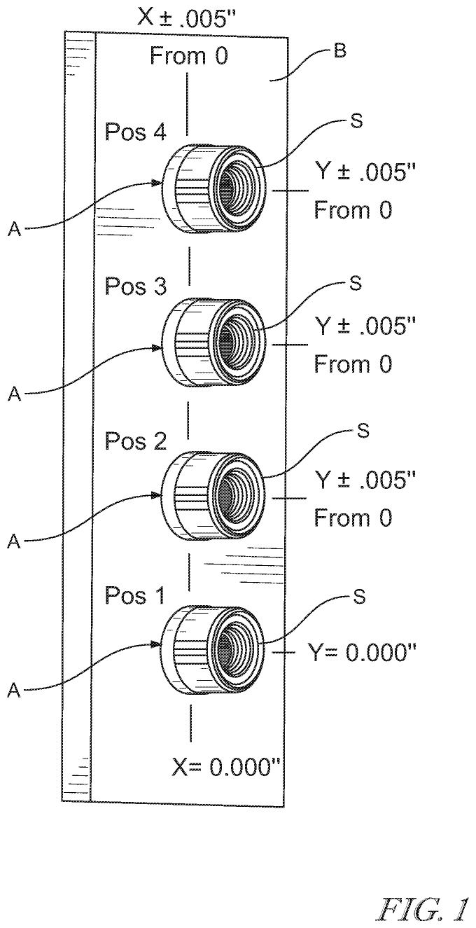

FIG. 1 shows a bus bar B as might be found in an electrical equipment cabinet (not shown). The bus bar BB defines four apertures A arranged linearly proximate four corresponding, predetermined aperture locations. The actual locations of the apertures A may vary somewhat from the predetermined aperture locations due to manufacturing tolerances. FIG. 1 also illustrates four electrical connector sockets S, each disposed within a corresponding one of the apertures A.

The predetermined aperture locations may correspond to predetermined locations of corresponding, mating electrical connector pins extending from a piece of electrical equipment (not shown) that may be removably received within the cabinet (not shown). The piece of electrical equipment may be, for example, an electrical equipment drawer removably receivable within the cabinet, or a piece of electrical equipment mounted on such a drawer. The actual locations of the pins (not shown) may vary somewhat from the corresponding predetermined aperture locations due to manufacturing tolerances.

The foregoing deviations of the aperture and pin locations from the respective predetermined locations, as well as manufacturing variations in the sockets S and the pins (not shown) themselves, can yield misalignment of respective sockets and pins. At worst, the misalignment may preclude insertion of the pins into the sockets. In less severe cases, the misalignment may adversely affect the quality of the electrical connection between the respective pins and sockets.

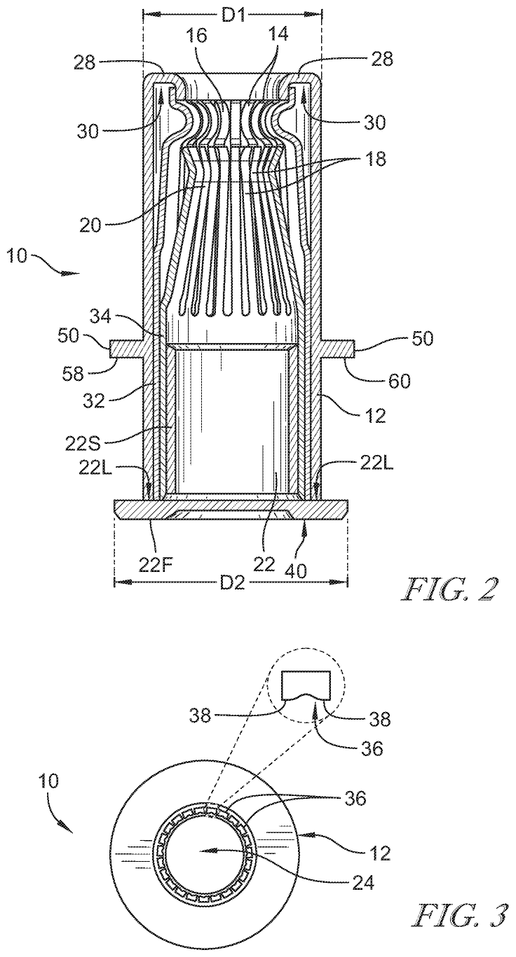

FIGS. 2 and 3 show an illustrative electrical contact element 10 including a generally cylindrical housing 12, a first generally cylindrical array 14 of flexible beams 16 received concentrically within the housing 12, a second generally cylindrical array 18 of flexible beams 20 received concentrically within the first array 14 of flexible beams 16, and a ferrule 22 having an annular shaft 22S received concentrically within the second array 18 of flexible beams 20. Individually and collectively, the housing 12, the first array 14 of flexible beams 16, the second array 18 of flexible beams 20, and the ferrule 22 define a cavity configured to seperably receive a pin of a contact element of a mating electrical connector (not shown).

The housing 12 is shown as an annular sidewall having a first end and a second end. The sidewall of the housing 12 has an outer diameter D1 and an inner diameter D2. A hood 28 extends radially inwardly from the second end of the housing 12 and then turns toward the first end of the housing 12, thereby defining an annular channel or slot 30 between the sidewall of the housing 12 and the free end of the hood 28.

A circumferential flange 50 extends radially outwardly from the sidewall of the housing 12 intermediate the first end and the second end of the sidewall. In the embodiment shown, the circumferential flange 50 encircles the entirety of the housing 12. The circumferential flange 50 has an outside diameter substantially greater than the outside diameter of the sidewall of the housing 12.

The first array 14 of flexible beams 16 is shown as extending from a generally cylindrical base 32 abutting the housing 12 proximate the first end thereof. The first array 14 of beams 16 extends axially from the base 32 and radially inwardly toward the center of the cylinder defined by the first array 14 of flexible beams 15. Similarly, the second array 18 of flexible beams 20 is shown as extending from a generally cylindrical base 34 abutting the base 32 of the first array 14 of flexible beams 16 proximate the first end thereof. The first array 18 of flexible beams 20 extends axially from the base 34 and radially inwardly toward the center of the cylinder defined by the second array 18 of flexible beams 20. In an embodiment, the second array 18 of flexible beams 20 may be omitted. In other embodiments, other electrical contact arrangements defining a cylindrical cavity could be provided in lieu of either or both of the arrays 14, 18 of flexible beams 16, 20.

As suggested above, the ferrule 22 includes a generally circular flange 22F defining an aperture therethrough, and a generally annular shaft 22S defining a bore extending therethrough. The shaft 22S is connected to the flange 22F so that bore of the shaft 22S is generally concentric with the aperture of the flange 22F. The flange 22F has a second outer diameter D3 substantially greater than the first outer diameter D1 of the housing 12. As such, the flange 22F defines a bearing surface or land 22L extending radially outwardly from the sidewall of the housing 12.

All of the foregoing components of the contact element 10 are electrically conductive, and they are electrically coupled to each other. The first inner diameter D2 of the housing 12, the outer diameter D3 of the shaft 22S, and the diameters of the bases 32, 34 of the first and second arrays 14, 18 of flexible beams 16, 20 are selected so that the bases 32, 34 are compressed against each other and between the housing 12 and the ferrule 22 when the housing 12, the first and second bases 32, 34, and the ferrule 22 are assembled as shown and as described above.

As best shown in FIG. 3, the distal portion of each of the flexible beams 16, 20 extending from the respective base 32, 34 defines a contact area 36 configured to engage the mating connector (not shown) in electrical contact therewith. In some embodiments, the contact area 36 may be formed to define two contact points or surfaces 38. In other embodiments, the contact areas 36 may be formed to define more or fewer than two contact points or surfaces 38. As best shown in FIG. 2, the distal end of each beam of the first array 14 of flexible beams 16 may be radially captured within the slot 30 defined by the sidewall of the housing 12 and the free end of the hood 28.

As suggested above, the contact element 10 may be configured to receive therein a pin of mating electrical connector (not shown) in electrical engagement, so that low force is required to assemble the mating connector element to, and to disassemble the mating connector element from, the contact element 10.

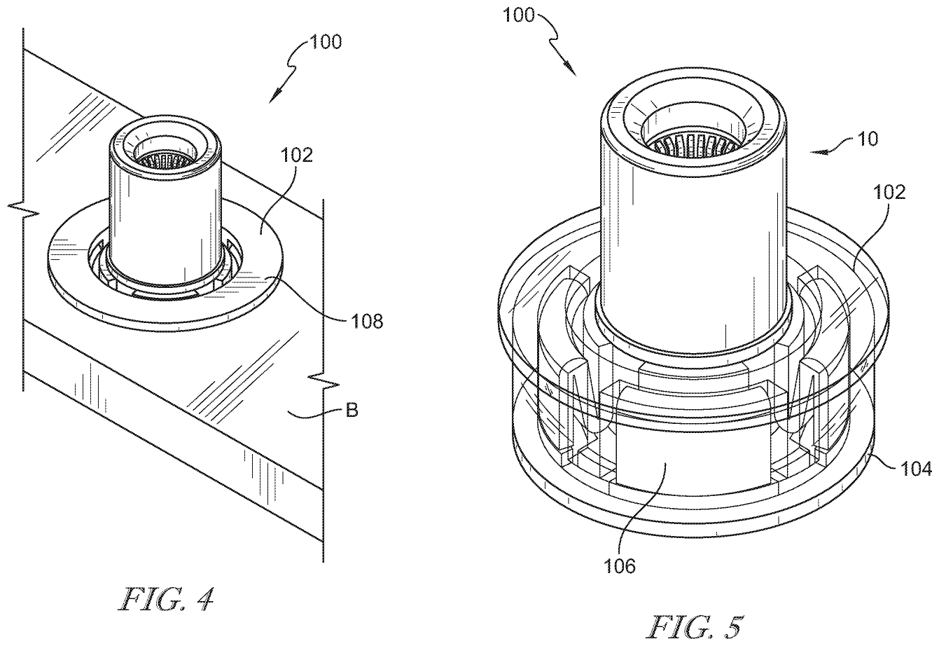

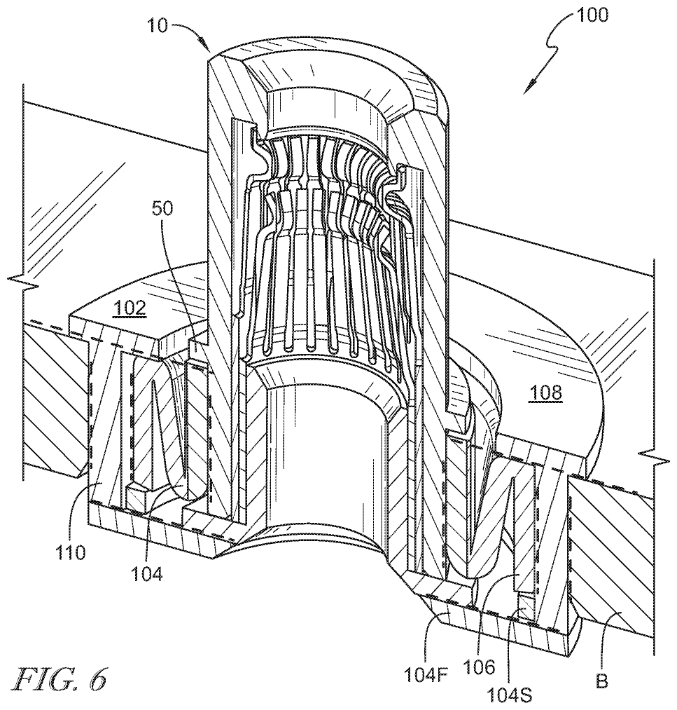

FIG. 4-6 show an illustrative embodiment of an electrical connector 100 according to the present disclosure. The electrical connector 100 is configured to be received within the aperture A of the bus bar B, and to receive a pin of a mating electrical connector (not shown) in secure mechanical and electrical engagement.

The connector 100 includes the contact element 10, a mounting base 102 configured to receive the contact element, a retainer 104 configured to capture the contact element 10 to the mounting base 102, a biasing element 106 disposed between the retainer and the base 102, and a retainer 104. At least the contact element 10 and the mounting base 102 are electrically conductive and in electrical engagement with each other. The biasing element 106 may be electrically conductive and in electrical engagement with the base 102 and the contact element 10.

More specifically, the mounting base 102 includes a generally circular flange 108 defining an aperture therethrough. The aperture defined by the flange 108 has an inner diameter substantially greater than the outer diameter of the housing 12 and the flange 50 of the contact element 10. A generally cylindrical sidewall 110 defining a bore therethrough extends axially from the flange 108, with the bore of the sidewall 110 generally concentric with the aperture of the flange 108. The bore defined by the sidewall 110 has an inner diameter substantially greater than the outer diameter of the housing 12 and the circumferential flange 50 of the contact element 10, thereby allowing substantial lateral (or radial) displacement of the housing 10 and the circumferential flange 50 with respect to the sidewall 110 when the contact element 10 is assembled to the base 102 as shown and as will be discussed further below. The base 102 is configured to be received within a bus bar B, for example, in press-fit engagement. The outer surface of the sidewall 110 may be knurled to effect secure mechanical and electrical engagement between the base 10 and the bus bar B.

The retainer 104 is shown as a ferrule having a flange 104F and a shaft 104S extending axially from the flange 104F. The flange 104F and the shaft 104S cooperate with each other to define an aperture therethrough. The shaft 104S has an outer diameter complementary to the inner diameter of the sidewall 110 of the housing so that the shaft 104S of the retainer 104 may be press-fit to the sidewall 110 of the base 20 to capture the biasing element 106 therebetween when the base 102, the biasing element 106, and the retainer 104 are assembled together as shown.

The biasing element 106 is an arcuate member having a Z-shaped cross-section and, as such, has first and second parallel legs and a diagonal leg connecting one end of the first parallel leg with an opposite end of the second parallel leg. The first parallel leg is parallel to and in electrical engagement with the housing 12 of the contact element 10, and the second parallel leg is parallel to and in electrical engagement with the sidewall 10 of the base 102. The biasing element 106 has an inner diameter and an outer diameter selected so that biasing element 106 is in press-fit engagement with the housing 12 of the contact element 10 and the sidewall 110 of the base 102 when the contact element 10, the base, and the biasing element 106 are assembled together as shown. The biasing element may be provided as a single annular or otherwise continuous arcuate member, or as a plurality of distinct arcuate members.

The connector 100 may be assembled by receiving the contact element 10 within the base 102, and receiving the biasing element(s) between the housing 12 of the contact element and the sidewall 110 of the base 102, and further by receiving the shaft 104S of the retainer 104 within the sidewall 110 of the base 102 in press-fit engagement. So assembled, the contact element 10 is free to be pivotably and/or radial displaced with respect to the base 102 in response to a pivoting or radial displacement force as may be applied by a pin of a mating connector element (not shown) engaged therein.

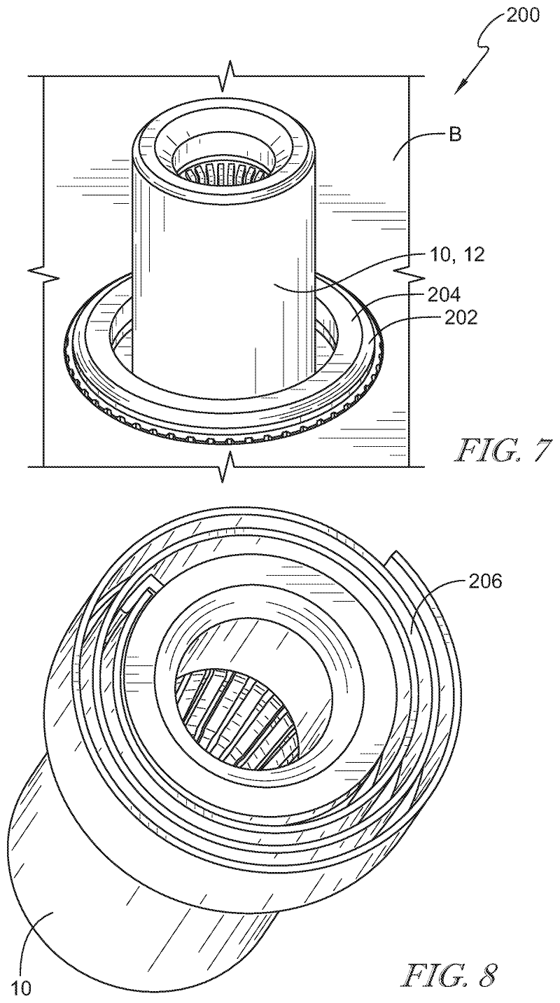

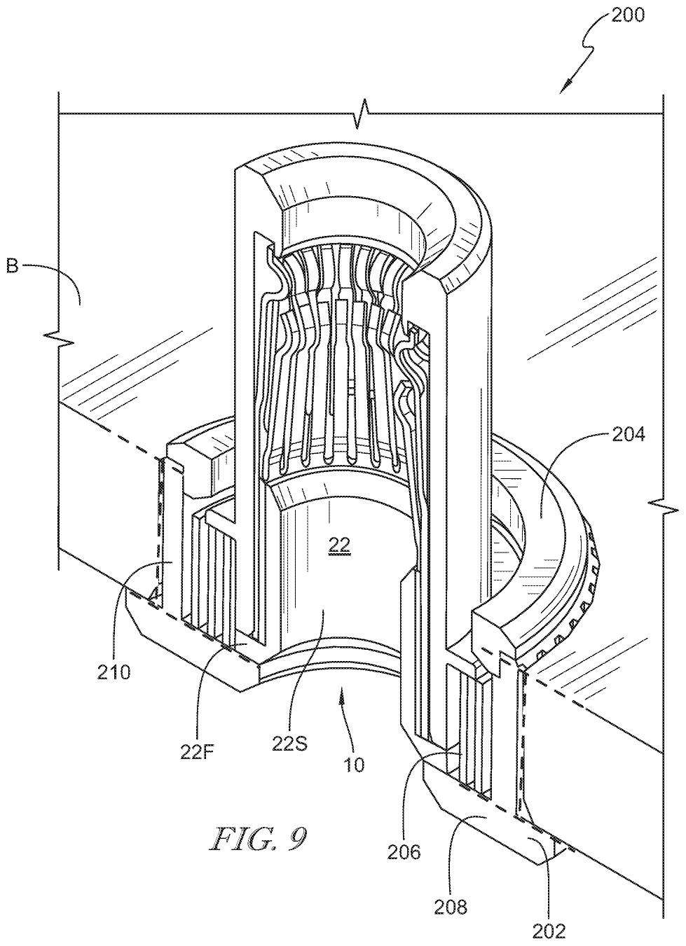

FIGS. 7-9 show an illustrative second embodiment of an electrical connector 200 according to the present disclosure. The electrical connector 200 is configured to be received within the aperture A of the bus bar B, and to receive a pin of a mating electrical connector (not shown) in secure mechanical and electrical engagement.

The electrical connector 200 is similar to the electrical connector 100. The electrical connector 200 differs from the electrical connector 100 primarily in that the outer diameter of the flange 22F of the ferrule 22 is equal to the outer diameter of the shaft 22S thereof, the locations of the base 202 and the retainer 204 are inverted from the locations of the base 202 and the retainer 204 with respect to the bus bar B, and the biasing element 206 is embodied as a clock spring or spiral, rather than an annular Z-shaped member.

The electrical connector 200 may be assembled by receiving the contact element 10 within the biasing element 206 within the base 202, receiving the housing 12 of the contact element 10 within the biasing element 206 so that the flange 50 extending radially outwardly from the housing 12 captures the biasing element 206 between the flange 50 and the flange 208 of the base 202, and securing the retainer 204 to the sidewall 210 of the base 202.

So assembled, the contact element 10 is free to be pivotably and/or radial displaced with respect to the base 202 in response to a radial displacement force as may be applied by a pin of a mating connector element (not shown) engaged therein. The biasing element 206 imparts a radial biasing force to the contact element 10 thereby biasing the contact element to a neutral position with respect to the base. The neutral position may be concentric with the base 102. A gap may be provided between an upper surface of the flange 50 of the contact element 12 and a lower surface of the retainer 206, thereby further allowing the contact element 10 to pivot with respect to the base 202 in response to a pivoting displacement force as may be applied by a pin of a mating connector element (not shown) engaged therein.

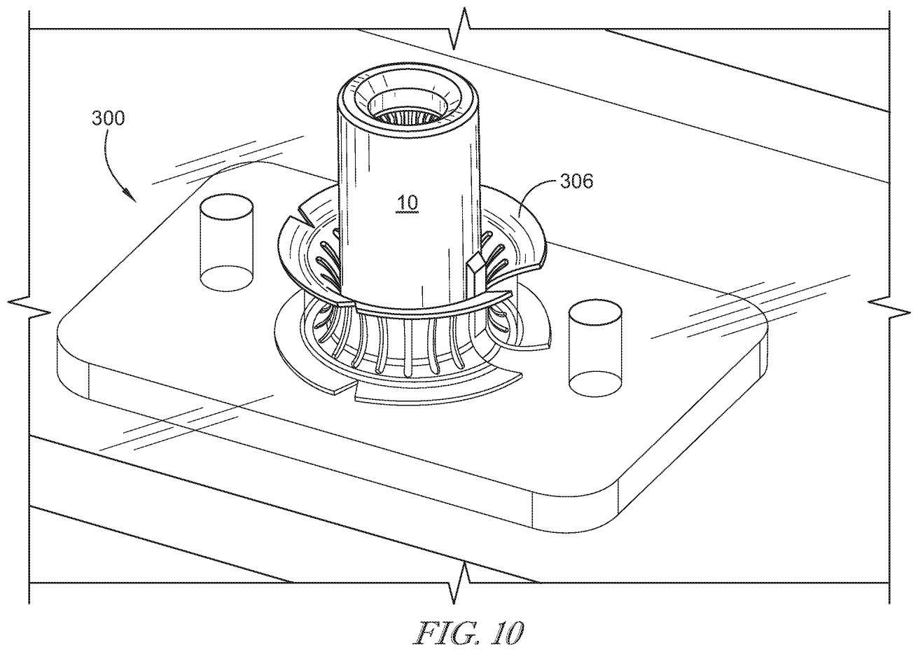

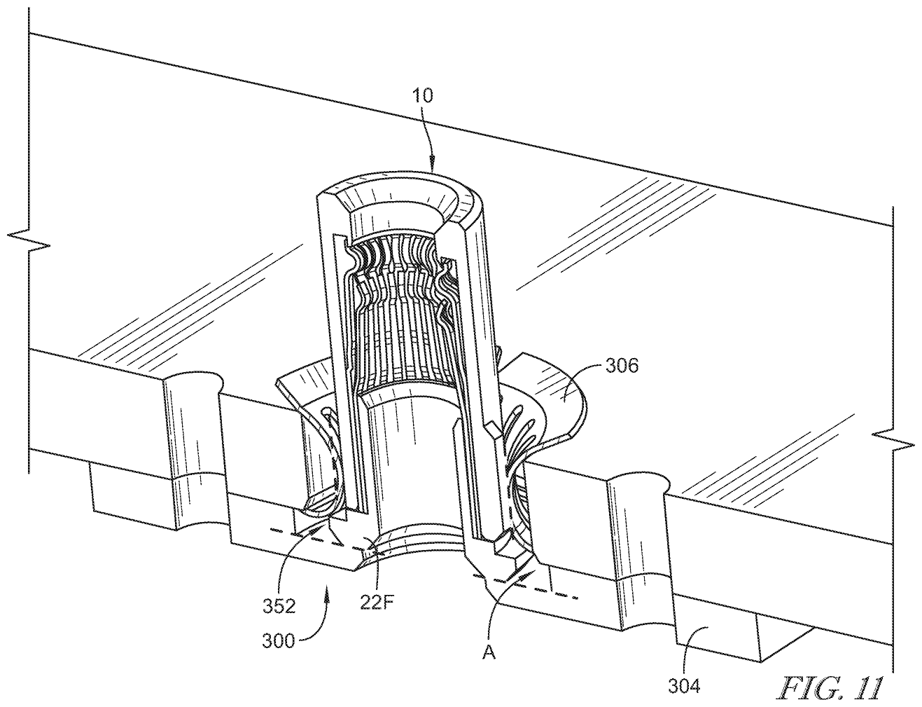

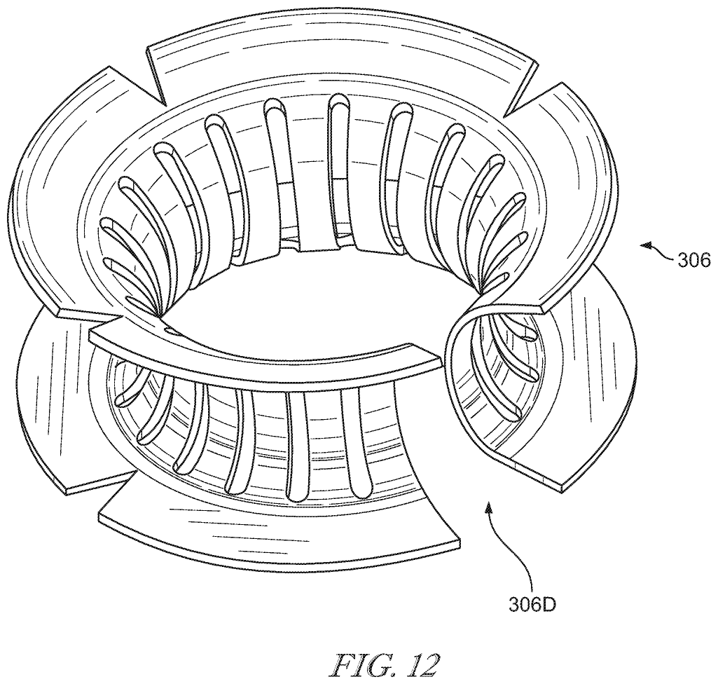

FIGS. 10-12 show an illustrative third embodiment of an electrical connector 300 according to the present disclosure. The electrical connector 300 is configured to be received within the aperture A of the bus bar B, and to receive a pin of a mating electrical connector (not shown) in secure mechanical and electrical engagement.

The connector 300 includes the contact element 10, a retainer 304, and a generally semi-toroidal biasing element 306 having upper and lower edges. Though generally semi-toroidal, thereby defining a bore therethrough, the biasing element 306 has first and second ends defining a discontinuity 306D. The discontinuity 306D is of sufficient extent as to allow the first and second ends of the biasing element 306 to resiliently compressed toward each other to thereby facilitate insertion of the biasing element 306 into the aperture A of the bus bar B. With the biasing element 106 received within the aperture, the upper edge of the biasing element overlies an upper surface of the bus bar B, and the lower edge of the biasing element 306 overlies a lower surface of the bus bar B.

The contact element 10 is received within the bore defined by the biasing element 306. The flange 22F of the contact element 10 is proud of the lower surface of the bus bar B and the corresponding portion of the biasing element 306.

The retainer 304 is configured for connection to the bus bar B by pins, rivets, or other means. As shown, the retainer 304 is embodied as a late defining a cavity 352 configured to receive the flange 22F of the contact element 10 and to capture the contact element 10 to the bus bar B and the retainer 304 when the contact element 10, the biasing element 306, and the retainer 304 are assembled together as shown.

So assembled, the contact element 10 is free to be pivotably and/or radial displaced with respect to the bus bar B in response to a radial displacement force as may be applied by a pin of a mating connector element (not shown) engaged therein. The biasing element 306 imparts a radial biasing force to the contact element 10 thereby biasing the contact element to a neutral position with respect to the bus bar B. The neutral position may be concentric with the aperture A defined by the bus bar B.

Various illustrative, non-limiting embodiments of an electrical connector and mating connector are shown and described herein. Features shown in connection with a given embodiment may be incorporated into any other embodiment to the greatest extent possible. Dimensions, tolerances, and the like that may be shown or described herein are illustrative and not limiting.

1. An electrical connector for use with a separable mating electrical connector, the electrical connector comprising:
an annular base configured for secure insertion into an aperture defined by a bus bar, the annular base defining a bore having an inner diameter, and the annular base having a longitudinal axis;
an annular contact element disposed within the bore of the base, the annular contact element having a first end and a second end, the annular contact element defining a bore configured to receive a pin of the separable mating connector in continuous electrical engagement therewith, the annular contact element comprising:
an annular housing having an inner diameter and an outer diameter lesser than the inner diameter of the bore of the base; and
a circumferential flange extending radially outwardly from the housing proximate an intermediate portion of the housing, the first circumferential flange having an outer diameter; and
a semi-toroidal biasing element configured to exert a radial biasing force between the bus bar and the annular contact element, and
an annular retainer capturing the annular contact element to the annular base,
wherein the annular contact element is electrically engaged with the annular base.
